(19) United States
(12) Patent Application Publication
(10) Pub. No.: US 2015/0109688 A1
(43) Pub. Date: Apr. 23, 2015

(54) MAGNIFYING CARD

(71) Applicant: Darren M Teren, San Diego, CA (US)

(72) Inventor: Darren M Teren, San Diego, CA (US)

(21) Appl. No.: 14/285,330

(22) Filed: May 22, 2014

Related U.S. Application Data
(60) Provisional application No. 61/894,557, filed on Oct. 23, 2013.

(51) Int. Cl. G02B 25/00; G06K 19/00; G02B 3/08

(52) U.S. Cl. CPC G02B 25/002; G02B 3/08; G02B 25/005; G06K 19/00
USPC 359/742; 359/809; 29/460

(57) ABSTRACT

A card has a planar first portion that includes readable data and a second portion that includes a lens. The card can be a credit card and the data can be financial data. The lens provides magnification.

### RELATED APPLICATIONS

This application claims priority under 35 U.S.C. §119(e) to U.S. Provisional Patent Application Ser. No. 61/894,557 (filed Oct. 23, 2013) which is hereby expressly incorporated by reference in its entirety.

### BACKGROUND OF THE INVENTION

1. Field of the Invention

The present invention relates generally to the magnification of printed material with a pocket sized device and more specifically relates to a financial transaction card having a magnifying lens disposed in at least a portion thereof.

2. Description of the Related Art

Most financial transaction cards, such as credit cards, ATM cards, and gift cards, have a common size and shape. Many cards have a size which conforms to ISO/IEC 7810 ID-1. The cards commonly include a magnetic stripe configured to store data. Other physical properties of the cards are often governed by various domestic and international standards.

### SUMMARY OF THE INVENTIONS

The devices, systems, and methods of the present disclosure have several features, no single one of which is solely responsible for its desirable attributes. Without limiting the scope of this invention as expressed by the claims which follow, its more prominent features will now be discussed briefly. After considering this discussion, and particularly after reading the section entitled “Detailed Description of Certain Embodiments,” one will understand how the features of this disclosure provide several advantages over other systems.

One aspect is a card that comprises a planar first portion including readable data and a second portion including a lens. The data may be financial data. The card may be a credit card. The first portion of the card may comprise a plurality of layers. At least one of the plurality of layers may comprise an opening. At least part of the second portion may be disposed within the opening. In some embodiments, the second portion overlaps the first portion. In other embodiments, the second portion does not overlap the first portion. The second portion may be disposed in a lower right corner of the card. The lens may be a Fresnel lens. The lens may be convex. The lens may provide a magnifying power between 1 and 6. The size of the second portion may be coextensive with a size of the card.

In some embodiments, the second portion is movable with respect to the first portion. For example, the second portion may rotate relative to the first portion. In some embodiments, the second portion may slide relative to the first portion. The second portion may include a window. The lens may be disposed in the window. The second portion may include a rim. The rim may be disposed about an outer periphery of the lens. At least a portion of the card can be made of polyvinyl chloride acetate (“PVCA”). In some embodiments, the card further includes a channel. An outer periphery of the second portion may be disposed in the channel. The lens may be the size of a financial transaction card and include readable payment information.

In another aspect, a card may comprise a planar card body including readable data. The card body may have at least one opening therethrough. A magnifying lens may be secured within the opening. The magnifying lens may be a Fresnel lens. A first coating may be disposed over a top surface of the card body and a top surface of the lens. A second coating may be disposed over a bottom surface of the card body and a bottom surface of the lens. The coatings may comprise a clear protective film.

Another aspect includes a method of manufacturing a financial transaction card. The method may include providing a planar card body, the card body configured to store computer readable data, forming an opening in the card body, inserting a magnifying lens secured within the opening, and coating at least one surface of the card body and the magnifying lens.

### BRIEF DESCRIPTION OF THE DRAWINGS

The features, aspects, and advantages of the invention disclosed herein are described below, with reference to the drawings of certain embodiments, which are intended to illustrate and not to limit the invention. Additionally, from figure to figure, the same reference numerals have been used to designate the same components of an illustrated embodiment. The following is a brief description of each of the drawings:

FIG. 1 is a plan view of a front side of a card having a magnifying lens disposed therein according to a preferred embodiment of the present invention.

FIG. 2 is an exploded perspective view of the card from FIG. 1.

FIG. 3 includes plan views of a front side and a back side of a card having a magnifying lens disposed therein according to a preferred embodiment of the present invention.

FIG. 4 is a top view of a sales receipt in proximity to the back side of the card from FIG. 3.

FIG. 5 is similar to FIG. 4 except the magnifying lens portion of the card has been aligned with a portion of the sales receipt to magnify text on the sales receipt.

FIG. 6 is a cross-sectional view through layers of the card taken along line 4-4 shown in FIG. 3 showing at least a portion of one of the layers including the magnifying lens.

FIG. 7 is an exploded cross-sectional view similar to FIG. 6.

FIGS. 8A and 8B are plan views of another embodiment of a card having a magnifying lens. As shown, the magnifying lens is movable between a first position where the magnifying lens is disposed over at least a portion of the card, FIG. 8A, and a second position where the magnifying lens extends from the card, FIG. 8B.

FIG. 9 is a partial cross-sectional view of the card taken along line 7-7 shown in FIG. 8B.

### DETAILED DESCRIPTION OF THE PREFERRED EMBODIMENTS

The following description and examples illustrate preferred embodiments of the present invention. More specifically, the following embodiments relate to a functioning financial transaction card having a magnifying window and/or lens disposed therein. The magnifying window may provide a means for magnifying printed material. In this way, a user may use the device to make a payment and also use the device to verify information on, for example, a credit card or charge card receipt without the need for a separate magnifying lens and/or eye glasses.

The following description and the accompanying figures, which describe and show the preferred embodiments, are made to demonstrate several possible configurations that a card having a magnification element can take to include the various disclosed aspects and features. Various aspects will now be described with reference to specific forms or embodiments selected for purposes of illustration. It will be appreciated that the spirit and scope of the cards and lens systems disclosed herein are not limited to the selected forms. Moreover, it is to be noted that the figures provided herein are not drawn to any particular proportion or scale, and that many variations can be made to the illustrated embodiments. Brief introductions to some of the features, which are common to the described embodiments of the device, are now described.

The preferred embodiments advantageously provide a device that may be used as a financial transaction card and a magnifying lens. Financial cards include, for example, credit cards, debit cards, and charge cards. The card containing the lens may conform to international standards for financial transaction cards and may have the same physical properties and characteristics as, for example, a credit card. In general, the lens is located in at least a portion of the card. In certain embodiments, the lens is only part of the card. In other embodiments, the lens is the entire card. Preferably the lens is located in an area on the card that allows the card to still perform its transaction function. For example, the lens could be located in a region of the card that is not used to store or display vital credit card data. Thus, the lens is positioned such that the functioning of the credit card is maintained. The lens may be included in the card during the manufacturing process or may be inserted in a previously manufactured card. The lens may be a substantially rigid, transparent plastic element having approximately the same physical properties as the materials used to manufacture the card.

In some embodiments, the lens is approximately the same thickness as the card. In other embodiments, the lens is thinner than the card. In certain embodiments the lens is slightly thicker than the card but is not thick enough to prevent the card from interfacing with financial transaction machines and the like. The lens may be substantially flat. The lens may comprise a Fresnel lens. The card may be formed with an opening and/or an opening may be formed within the card. The lens may be inserted into the opening. In some embodiments, the lens includes a ridge or lip extending from one or more sides of the lens. The ridge or lip may be sized to be larger than the opening and thus may extend out from the opening over a top and/or bottom surface of the card. In some embodiments, one or more perimeter edges of the lens include one or more support structures that may be insertable into one or more slots surrounding the perimeter of the opening. After the lens is inserted into the opening, the card and lens may be coated with a top coating and/or a bottom coating. In some embodiments, the top coating and/or bottom coating comprises a clear protective film.

To facilitate a complete understanding of the embodiments, the remainder of the detailed description describes the invention with reference to the figures; wherein like elements among the embodiments are referenced with like numerals throughout the following description.

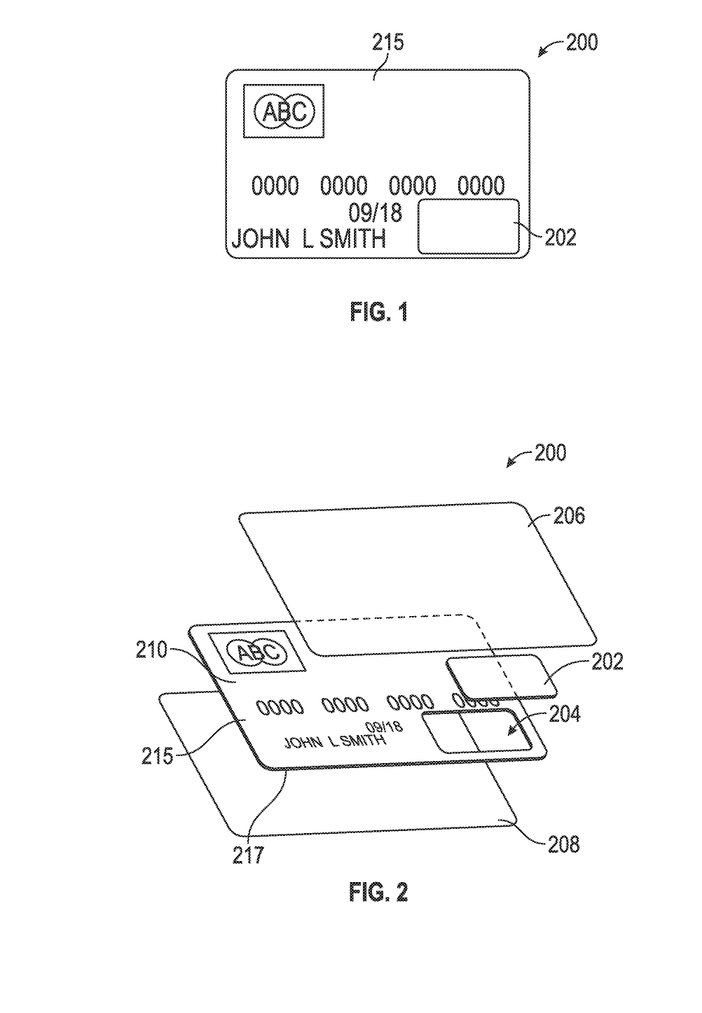

FIG. 1 is a plan view of a front side 215 of a card 200 having a magnifying lens 202 disposed therein according to a preferred embodiment of the present invention. The card 200 may be sized and shaped according to international standards for financial cards. In some embodiments the card 200 is formatted according to ISO/IEC 7810 ID-1. In these embodiments, the card 200 has a thickness of 0.76 mm (0.030 in).

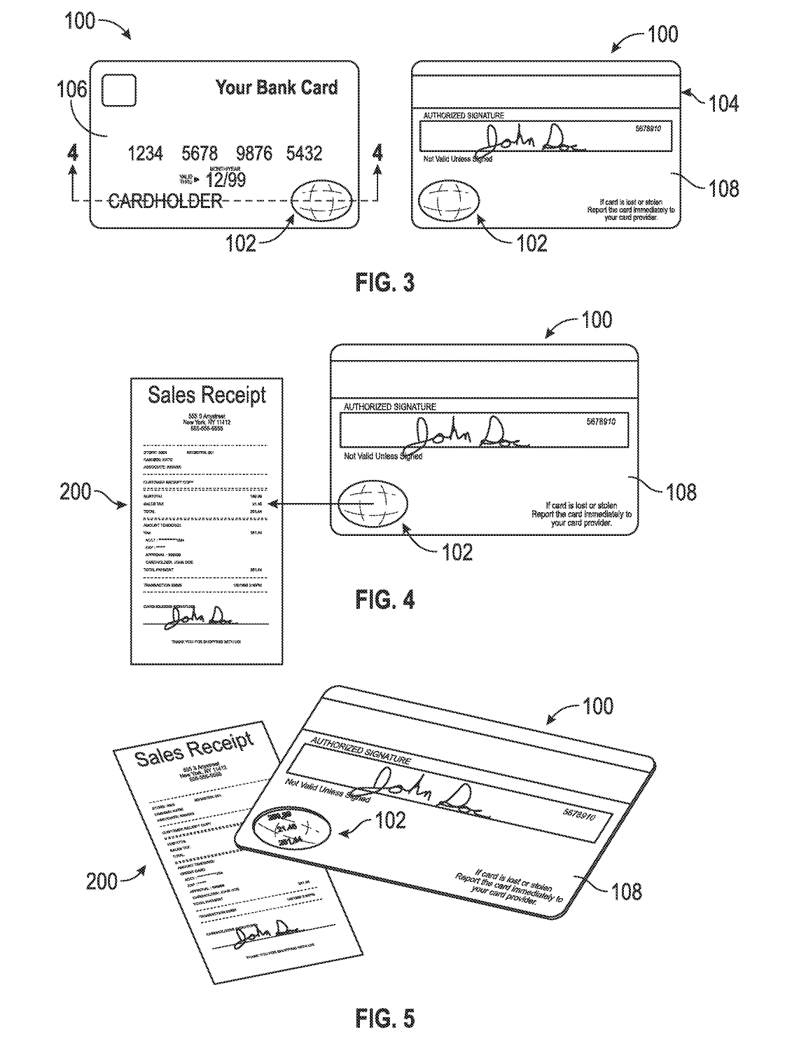

As shown in FIG. 2, the card 200 includes a card body 210 having an opening 204 therethrough. As shown, the opening 204 comprises a generally rectangular opening in the bottom right hand corner of the card body 210. However, one will appreciate that the opening 204 may be any suitable size and shape and may be located in any location in the card body 210. For example, the card embodiment illustrated in FIG. 3 has an oval opening.

Referring to FIG. 2, a lens 202 may be disposed within the opening 204. The lens 202 may be substantially the same thickness as the card body 210. Thus, in some embodiments, the lens 202 has a thickness of 0.76 mm (0.030 in). In other embodiments, the lens 202 is thinner or slight thicker than the card body 210. For example, according to one embodiment, the lens 202 is about 0.4 mm thick. Of course, one of skill in the art will recognize that the lens may be any suitable thickness depending on the desired thickness of the card and/or the desired magnification properties.

The lens 202 may include one or more support structures configured to retain the lens 202 within the opening 204. The support structures may help prevent the lens 202 from moving relative to the card body 210. For example, the support structure can inhibit movement of the lens 202 relative to the card body 210 in the horizontal and/or vertical direction.

In some embodiments, the lens 202 includes a logo or other design element. In some embodiments, the lens 202 includes a logo that is viewable off-axis or from an angle but is not visible or partially transparent when viewed directly on axis. In this way, the card 200 can include a logo in the space having the lens 202 while, at the same time, the lens 202 can function as a magnification tool when viewed directly overhead. An exemplary logo could be for a financial services corporation or bank.

The top surface 215 of the card 200 may be coated with a top coating 206 and the bottom surface 217 of the card 200 may be coated with a bottom coating 208. The coatings 206, 208 may comprise any suitable coating materials known in the art. The coatings may be any suitable thickness. In some embodiments, the coatings 206, 208 are about 0.05 mm thick. In other embodiments, the coatings 206, 208 are about 0.1 mm thick. In some embodiments, the coatings 206, 208 comprise a clear protective film. The top and bottom coatings 206, 208 may secure the lens 202 within the opening 204. The coating 206, 208 may not adversely affect the card 200 and/or the lens 202. For example, the coating 206, 208 may not adversely affect the readability of the magnetically encoded stripe. The coating 206, 208 may comprise a vinyl polymer such as polyvinylchloride. The coating 206, 208 may further protect the card 200 and/or lens 202 from abrasion and/or wear.

FIG. 3 includes plan views of a front side 106 and a back side 108 of a card 100 having a magnifying lens 102 disposed therein according to a preferred embodiment of the present invention. The card may be a financial card including, for example, credit cards, debit cards, and charge cards.

As shown, the front side 106 of the card 100 may include information such as card name, bank name, account number, card holder name, and expiration date. The back side 108 of the card 100 can include a magnetic strip and a signature block. The magnetic strip or mag-stripe can store data that can be read by a suitable card reader. In some embodiments, the card may also include an RFID tag, a transponder device, and/or a microchip. The location on the card 100 where data is displayed on or encoded in the card 100 may vary depending on the specific card. Thus, the location of the lens 102 is preferably selected such that the data displays and encoding are not altered or are at least still function. In this way, the functionality of the card as a financial instrument is maintained.

The lens 102 may be positioned at any location on the card 100 such that the functionality of the card is maintained. As shown in FIG. 3, the lens 102 is disposed in the lower right hand corner of the top side 106 of the card 100. Commonly, the “real estate” at the lower right hand corner of the card 100 of a typical financial card is not used to display or encode vital information.

The lens 102 may also be any suitable size or shape. For example, the lens 202 can have a round, square, rectangular, or other shape. The lens 102 may have a thickness that is greater or less than a thickness of the card 100. The thickness of the lens 102 may vary across the lens 102. As shown in FIG. 3, the lens 102 is roughly elliptically shaped. Such an oblong circular shape may prevent the lens 102 from rotating within an opening in the card that the lens 102 is placed in. In some embodiments, the card 100 includes more than one lens 102. In other embodiments, the lens 102 comprises a strip that extends from one side of the card 100 to the other. In some embodiments, the entire card 100 comprises the lens 102. In such an embodiment, the data displays and encoding required to maintain the functionality of the card is part of the lens 102. In some embodiments, the lens 102 includes a coating.

In certain embodiments, the lens 102 includes an outer rim or outer perimeter while still maintaining an inner lens portion. The outer rim can be opaque while the inner lens portion is transparent. The rim can be made from the same material as the lens 102 or from a different material. The material of the rim portion can be selected to facilitate assembly or manufacturing. For example, the rim can be made of a material which provides an improved bond with the card 100 over a direct bond between the lens 102 and the card 100. In such an embodiment, the rim can also provide structural support to the perimeter of the lens 102.

The card 100 may be made of materials commonly used to make credit cards. Such materials include polyvinyl chloride acetate (“PVCA”). In general, the card 100 is rigid yet bendable and resistant to flame, chemicals, temperature, and humidity. The exact physical characteristics and/or construction of the card may conform to one or more international standards. In some embodiments, the card 100 includes a multi-laminate construction.

The lens 102 may be made of any material suitable for a magnifying lens. Such materials include polycarbonate, PVC, and glass. In some embodiments, the material can provide the magnification. In some embodiments, the lens 102 is convex. In some embodiments, the lens 102 is a Fresnel lens. In some embodiments, the lens 102 provides a magnifying power between 1 and 6. In some embodiments, the lens 102 provides a magnifying power of at least 3.

Turning to FIG. 4, a top view of a sales receipt 200 and the back side 108 of the credit card 100 having a magnifying lens 102 disposed therein is shown. Typically, after a transaction is made with a financial transaction card, the card holder is given a receipt to verify and/or adjust the payment amount. The card holder then signs the receipt to verify the final payment amount. Often, such receipts are printed in small print and/or have poor color contrast such that they may be difficult to read, especially in low light. As such, the lens 102 of the card 100 described herein may be positioned over portions of the receipt to better view the printed material. For example, as shown in FIG. 5, the card 100 may be held at a distance away from the receipt 200 such that the printed material is magnified when viewed through the lens 102. In some embodiments, the card 100 may be placed directly on the receipt 200. The printed material is then magnified when viewed through the lens 102.

In some embodiments, the card 100 further includes a light emitting device. The light emitting device may be activated by a button or switch disposed on the card 100. The light emitting device may be powered by a battery or other energy storage device disposed within the card 100. The battery may be rechargeable. The battery may be wirelessly recharged. In some embodiments, the outer rim or periphery of the lens 102 includes a light emitting device. In this way, images may be illuminated and magnified when viewed through the lens 102.

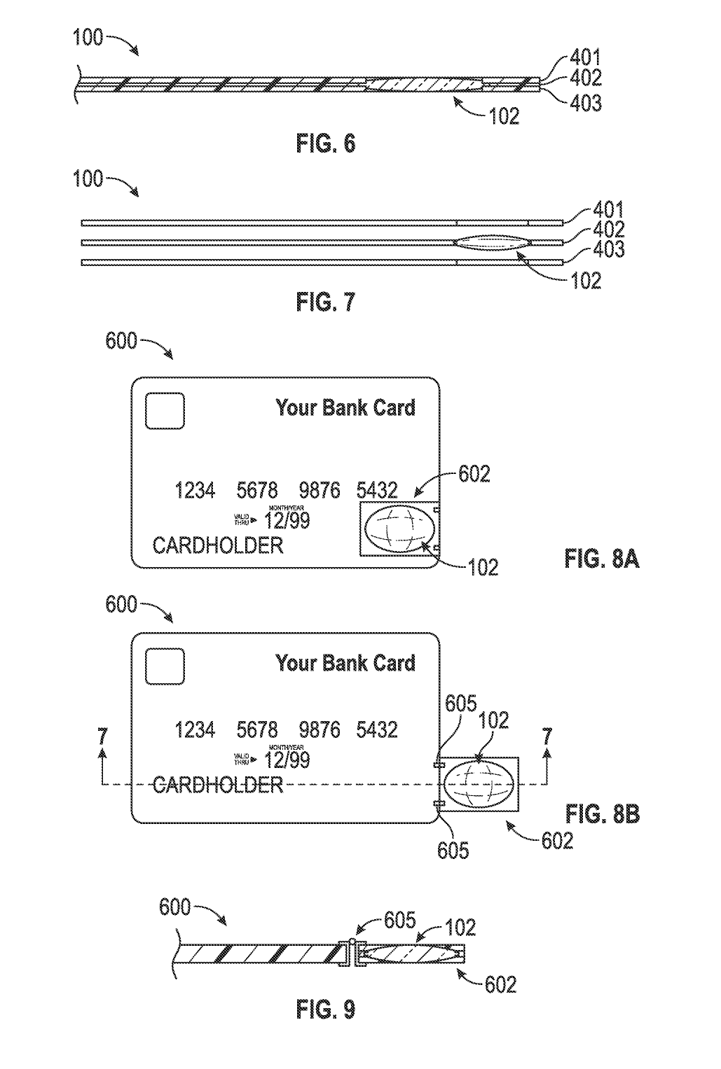

FIG. 6 is a cross-sectional view through layers 401, 402, 403 of the card 100 taken along line 4-4 shown in FIG. 3 showing at least a portion of one of the layers 402 including the magnifying lens 102. FIG. 7 is an exploded cross-sectional view similar to FIG. 6. In some embodiments, the card 100 having a magnifying lens 102 includes a multi-layer construction. In the illustrated embodiment, the card 100 includes three layers 401, 402, and 403. However, the card 100 may include more or less layers, including a single layer. As shown, the layer 402 includes the lens 102. The layer 402 and lens 102 can have a unitary construction or the layer 402 and lens 102 can have a non-unitary construction. In certain, embodiments, the lens 102 is assembled with the layer 402 prior to the layer 402 being assembled to the card 100.

In the illustrated embodiment, the lens 102 is convex. Of course the lens 102 need not be convex but can have any shape that provides the desired magnification. In certain embodiments, the lens 102 is a Fresnel lens. For example, a Fresnel can have flat shape. In some embodiments, the layer 402 is made of the same material as the lens 102. In certain embodiments, at least a portion of the top layer 401 and at least a portion of the bottom layer 403 overlap a portion of the lens 102. In this way, the lens 102 is larger than the openings in the layers 401, 403. The overlapping portions of the two layers 401, 403 form a groove or channel. The groove or channel can be configured to further support the periphery or rim of the lens 102. In this way, the lens 102 is further secured within the card 400. In certain embodiments, the opening in one or more layers 401, 403 is smaller than the opening in the layer 402. In such an embodiment, a ridge is formed which can abut the periphery or outer rim of the lens 102 to provide additional support at an interface between the lens 102 and the layer 402. Thus, the lens 102 may be formed during the manufacture of the card 100.

In another embodiment, the lens 102 is inserted into a pre-made card. The pre-made card may already include one or more laminated layers 401, 402 and/or 403. For example, an opening through the one or more layers 401, 402, 403 in the card 100 may be made with, for example, a die cutter. The opening is preferably made in an area of the card 100 that does not include printed or embedded data. The lens 102 is then inserted into the opening. In some embodiments, a channel, groove, lip, or ledge is provided around the opening to at least partially support the lens 102 relative to the card 100. In some embodiments, the lens 102 and/or opening are configured such that the lens 102 may form a snap fit with the opening. In some embodiments, an adhesive is used to secure the lens 102 within the opening. In some embodiments, the lens 102 is secured in the opening using sonic welding. In some embodiments, additional laminate materials are used to secure the lens 102 within the opening.

FIGS. 8A and 8B are plan views of another embodiment of a card 600 having a magnifying lens 102. As shown, the magnifying lens 102 is movable between a first position where the magnifying lens 102 is disposed over at least a portion of the card 600, FIG. 8A, and a second position where the magnifying lens 102 extends from the card 600, FIG. 8B. The lens 102 may form part of a movable window 602. The window 602 and the lens 102 may have a unitary or non-unitary construction.

The window 602 can comprise a thin plastic sheet having a thickness which is not substantially greater than the card 600. The window 602 may be removably attached to the card 100. In some embodiments, a snap fitting is configured to removably attach the window 602 to an edge of the card 600. In certain embodiments, the snap fitting includes one or more hinges 605 configured to allow the window 602 to rotate about the edge of the card 600. In this way, the window 602 may be moved away from the card 600 in order to magnify images and then moved toward the card 600 when the card is stored. In another embodiment, the window 602 slides, rather than rotates, across the surface of the card 600. For example, the window 602 could be disposed between layers of the card 402 but allowed to slide away from the card 600 and relative to the layers. After use, the window 602 is slid back between the layers of the card 600. Of course the lens 102 need not have the window 602 and instead could slide itself relative to the card 402.

It is to be noted that the figures provided herein are not drawn to any particular proportion or scale, and that many variations can be made to the illustrated embodiments. Those of skill in the art will recognize that the disclosed aspects and features shown herein are not limited to any particular embodiment disclosed herein.

Of course, it is to be understood that not necessarily all objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the features of the cards disclosed in the various embodiments can be switched between embodiments. In addition to the variations described herein, other known equivalents for each feature can be mixed and matched by one of ordinary skill in this art to construct systems and techniques in accordance with principles of the present invention.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

What is claimed is:

1. A card comprising:
a planar first portion including readable data; and
a second portion including a lens.

2. The card of claim 1, wherein the data is financial data.

3. The card of claim 2, wherein the card is a credit card.

4. The card of claim 1, wherein the first portion comprises a plurality of layers.

5. The card of claim 4, wherein at least one of the plurality of layers comprises an opening, at least part of the second portion being disposed in the opening.

6. The card of claim 1, wherein the second portion overlaps the first portion.

7. The card of claim 1, wherein the second portion is disposed in a lower right corner of the card.

8. The card of claim 1, wherein the lens is a Fresnel lens.

9. The card of claim 1, wherein a size of the second portion is coextensive with a size of the card.

10. The card of claim 1, wherein the second portion is movable with respect to the first portion.

11. The card of claim 1, wherein the second portion includes a window, the lens being disposed in the window.

12. The card of claim 1, wherein the second portion includes a rim, the rim being disposed about an outer periphery of the lens.

13. The card of claim 1, wherein at least a portion of the card is made of polyvinyl chloride acetate (“PVCA”).

14. The card of claim 1 further including a channel, an outer periphery of the second portion being disposed in the channel.

15. A lens being a size of a financial card and including readable payment information.

16. The lens of claim 15, wherein the size conforms to ISO/IEC 7810 ID-1.

17. A card comprising:
a planar card body including readable data, the card body having at least one opening therethrough; and
a magnifying lens secured within the opening.

18. The card of claim 17, further comprising a coating disposed over a top surface of the card body and a top surface of the lens.

19. The card of claim 18, further comprising a coating disposed over a bottom surface of the card body and a bottom surface of the lens.

20. A method of manufacturing a financial transaction card comprising:
providing a planar card body, the card body configured to store computer readable data;
forming an opening in the card body;
inserting a magnifying lens within the opening; and
coating at least one surface of the card body and the magnifying lens.
